(19) United States
(12) Patent Application Publication
(10) Pub. No.: US 2012/0203660 A1
(43) Pub. Date: Aug. 9, 2012

(54) CO-OCCURRENCE SERENDIPITY RECOMMENDER

(75) Inventors: Simon Moritz, Stockholm (SE); Morvarid Aprin, Stockholm (SE); Jonas Bjork, Stockholm (SE)

(73) Assignee: TELEFONAKTIEBOLAGET L M ERICSSON (PUBL), Stockholm (SE)

(21) Appl. No.: 13/500,749

(22) PCT Filed: Oct. 27, 2009
(86) PCT No.: PCT/SE2009/051223

§ 371 Date: Apr. 6, 2012

(51) Int. Cl. G06Q 30/00

(52) U.S. Cl. 705/26.7

(57) ABSTRACT

Methods, devices, and computer-readable media described herein may provide a recommender system that may increase the serendipity associated with a recommendation. The recommender system omits obvious co-occurred items, rare items, and limits a number of co-occurred items associated with an item table. Local and global weighting values may be calculated to derive a co-occurrence weight. The co-occurrence weight may be compared to maximum and minimum threshold co-occurrence values to omit obvious and rare co-occurred items.

### TECHNICAL FIELD

Implementations described herein relate generally to recommender systems. More particularly, implementations described herein relate to a distributed-based recommender system.

### BACKGROUND

Recommender systems are systems that aim to support users in their decision-making while interacting with an information space. Recommender systems may be classified based on the data that supports the recommendation and the algorithms that operate on the data. For example, recommender systems may be classified into various categories, such as, collaborative, content-based, knowledge-based, demographic, and utility-based. There are a variety of recommendation approaches, such as, for example, personalized, social, item, or a combination thereof.

Collaborative recommender systems use ratings from users to discover commonalities between a given user and other users and recommend items that similar users have rated favorably. Collaborative recommender systems utilize a collaborative filtering algorithm to provide item recommendations. One problem associated with this type of recommender system, however, is its growth potential. That is, the collaborative recommender system has to be able to manage an ever-growing repository of data stemming from the items, ratings of the items, and its users. One approach for handling this issue is to distribute the data. For example, a Chord-based recommender system may be implemented.

A Chord-based recommender system distributes the data to a certain number of item tables that may be hosted by a certain number of devices. An item table can include all users and their ratings for a particular item together with co-occurred items and their ratings. The item tables are distributed on the devices according to the Chord protocol. For example, the Chord protocol maps each device, as well as the data participating in the network, onto a Chord ring. A hash function is used to generate a node identifier for each device on the Chord ring. In a Chord-based recommender system, each user has a user profile that includes a list of items the user has utilized and rated. When the user makes a request for a recommendation, the Chord-based recommender system consults the user profile and then, using the hash function, performs a look-up to locate where the item tables associated with the items in the user profile are located. The Chord-based recommender system performs item-based collaborative filtering on the item tables and recommendation results are presented to the user.

However, a drawback to the collaborative recommender system is that the most similar items are typically recommended to the user. For example, if the user rated a movie (e.g., The Terminator) favorably, recommending to the user movies, such as, Terminator 2: Judgment Day, Terminator 3: Rise of the Machines, and/or Terminator Salvation may equate to an extremely obvious recommendation. It will be appreciated that a sequel of a particular content is merely an exemplification of a too obvious recommendation and that there may be other relationships between content that may constitute a too obvious recommendation. Additionally, or alternatively, items considered to be far less similar may not be recommended to the user (e.g., due to certain thresholds, due to ordering of item recommendation results, etc.).

A further drawback to the collaborative recommender system is that a distribution of the data can lead to substantial data redundancy (i.e., the co-occurred items are included in each of the other users' item tables). Thus, the collaborative recommender system may require more resources (e.g., storage resources, processing resources, etc.) and/or may negatively impact various performance metrics (e.g., response time).

### SUMMARY

It is an object to obviate at least some of the above disadvantages and to improve recommendation systems and the recommendation services provided to users. In exemplary implementations described herein, a recommender system may increase serendipity associated with a recommendation. In an exemplary implementation, the recommender system may omit obvious co-occurred items and/or rare co-occurred items from a recommendation, and/or limit the number of co-occurred items associated with an item. In an exemplary implementation, obvious co-occurred items and rare co-occurred items may be omitted by calculating a co-occurrence weight based on a global weighting factor and a local weighting factor. The calculated co-occurrence weight may be compared to a maximum threshold co-occurrence weight that may represent a measurement of obviousness. Additionally, the calculated co-occurrence weight may be compared to a minimum threshold co-occurrence weight that may represent a measurement of rareness (or disagreeableness to a user).

In an exemplary implementation, the recommender system may correspond to a distributed-based recommender system. For example, the recommender system may be implemented based on the Chord protocol.

According to one aspect, a method may be performed by devices that provide a recommendation of content to a user. The method may include distributing items in item tables stored by the devices; calculating whether an item has a co-occurrence with another item, which is associated with one of the item tables, where the calculating may comprise calculating a local weighting factor that represents a co-occurrence between the other item and co-occurred items included in the one of the item tables, calculating a global weighting factor that represent a co-occurrence between the item and the items in the item tables, calculating a co-occurrence weight based on the local weighting factor and the global weighting factor, and determining whether the co-occurrence weight satisfies one or more criteria; and storing the item as a co-occurred item in the one of the item tables when the co-occurrence weight is determined to satisfy the one or more criteria.

According to another aspect, one or more computer-readable media may store instructions to distribute items in item tables on devices; calculate whether an item has a co-occurrence with another item, which is associated with one of the item tables, where the instructions to calculate comprise instructions to calculate a local weighting factor that represents a co-occurrence between the other item and co-occurred items included in the one of the item tables, calculate a global weighting factor that represents a co-occurrence between the item and the items in the item tables, calculate a co-occurrence weight based on the local weighting factor and the global weighting factor, and determine whether the co-occurrence weight satisfies one or more criteria; and store the item as a co-occurred item in the one of the item tables when the co-occurrence weight is determined to satisfy the one or more criteria.

According to yet another aspect, devices in a network may include one or more processors and one or more memories to execute instructions to distribute items in item tables stored by the devices; calculate whether an item has a co-occurrence with another item, which is associated with one of the item tables, where, when calculating, the one or more processors are to calculate a local weighting value that represents a co-occurrence between the other item and co-occurred items included in the one of the item tables, calculate a global weighting value that represents a co-occurrence between the item and the items in the item tables, calculate a co-occurrence weight based on the local weighting value and the global weighting value, determine whether the co-occurrence weight satisfies one or more criteria, store the item as a co-occurred item in the one of the item tables when it is determined that the co-occurrence weight satisfies the one or more criteria; receive a recommendation request from a user; and send a recommendation response to the user based on the item tables.

### BRIEF DESCRIPTION OF THE DRAWINGS

FIG. 1 is a diagram illustrating an exemplary environment in which an exemplary recommender system described herein may be implemented;

FIG. 2 is a diagram illustrating exemplary components of a device that may correspond to one or more devices illustrated in the exemplary environment;

FIG. 3A is a diagram illustrating exemplary functional components associated with an exemplary recommender system;

FIG. 3B is a diagram illustrating an exemplary item table that may include an active item and co-occurred items;

FIG. 4 is a flow diagram illustrating an exemplary process for providing a recommender system and service;

FIG. 5 is a flow diagram illustrating an exemplary process for determining whether an item may be added as a co-occurred item in an item table; and

FIG. 6 is a diagram illustrating an exemplary distribution of items that includes obvious items and rare items.

### DETAILED DESCRIPTION

The following detailed description refers to the accompanying drawings. The same reference numbers in different drawings may identify the same or similar elements. Also, the following description does not limit the invention. Rather, the scope of the invention is defined by the appended claims.

Implementations described herein provide a recommender system that may exclude items that are considered too obvious for recommendation and/or excludes items that may be considered too rare (e.g., items that may be disagreeable to the user) for recommendation. In an exemplary implementation, the recommender system may exclude items based on one or more criteria. For example, the recommender system may limit the number of co-occurred items to be included in an item table. Additionally, or alternatively, the recommender system may require an item to satisfy a maximum threshold co-occurrence weight and/or a minimum threshold co-occurrence weight before being added as a co-occurred item in the item table. Unlike a conventional recommender system, the recommender system described herein may increase serendipity associated with items recommended to the user by excluding obvious items, rare items, and/or limiting the number of items included in the item table.

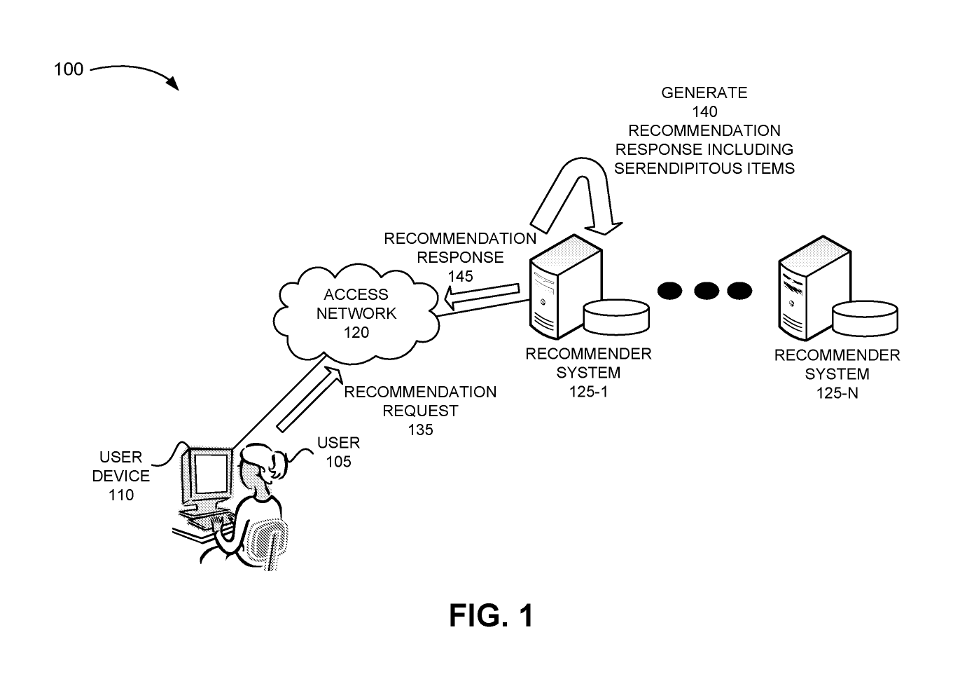

FIG. 1 is a diagram illustrating an exemplary environment 100 in which an exemplary recommender system described herein may be implemented. As illustrated, environment 100 may include a user 105, a user device 110, an access network 120, and distributed recommender system 125-1 through 125-N (where N>1) (referred to generally as recommender system 125).

The number of devices and configuration in environment 100 is exemplary and provided for simplicity. In practice, environment 100 may include more devices and/or networks, fewer devices and/or networks, different devices and/or networks, and/or differently arranged devices and/or networks than those illustrated in FIG. 1. For example, in other implementations, recommender system 125 may be implemented on a single network device (e.g., a centralized recommender system). Also, some functions described as being performed by a particular device may be performed by a different device or a combination of devices.

User 105 may correspond to a person that seeks a recommendation of an item. The item may correspond to a variety of things, such as, for example, a book, a movie, music, a consumer product (e.g., an appliance, clothes, a car, etc.), a service (e.g., professional services, such as, a doctor, a lawyer, etc.), a restaurant, a vacation spot, etc.

User device 110 may include a device capable of communicating with other devices, systems, networks, and/or the like. User device 110 may correspond to a portable device, a mobile device, or a stationary device. By way of example, user device 110 may take the form of a computer (e.g., a desktop computer, a laptop computer, a handheld computer, etc.), a personal digital assistant (PDA), a wireless telephone, a vehicle-based device, a Web-access device, or some other type of communication device. User device 110 may provide a user interface to recommender system 125.

Access network 120 may provide user device 110 access to recommender system 125. Access network 120 may include one or more networks of any type (i.e., wired and/or wireless). For example, access network 120 may include a local area network (LAN), a wide area network (WAN), a data network, a private network, a public network, the Internet, and/or a combination of networks. Access network 120 may operate according to any number of protocols, standards, etc.

Recommender system 125 may include multiple network devices corresponding to recommender system 125-1 through recommender system 125-N. The network devices may take the form of, for example, network computers, servers, or some other type of computational devices. In an exemplary implementation, recommender system 125 may operate according to the Chord protocol. In other implementations, recommender system 125 may operate according to some other protocol. For example, recommender system 125 may operate according to other distributed hash table protocols (e.g., Content Addressable Network (CAN), Tapestry, Kademlia, Koorde, or Pastry) or peer-to-peer (P2P) lookup algorithms. However, for purposes of discussion, recommender system 125 will be described in reference to the Chord protocol. In such an implementation, the network devices may form a Chord ring. A node identifier (ID) in a Chord ring may be determined using a hash function applied to a network address associated with the network device.

Recommender system 125 may distribute the data to item tables based on the Chord ring. In an exemplary implementation, each item may have a corresponding item table. For example, if recommender system 125 manages a thousand items, recommender system 125 may manage a thousand item tables. In an exemplary implementation, the information stored in an item table may include user identifiers, item identifiers, ratings, and co-occurred items. Each user 105 may have a user profile that includes a list of all the items user 105 has used and user's 105 ratings of these items. In an exemplary implementation, the user profile may be stored on user device 110.

As will be described, recommender system 125 may provide item recommendations to user 105. However, in contrast to a conventional recommender system, recommender system 125 may exclude items that are considered too obvious for recommendation and/or may exclude items that may be considered too rare (e.g., items that may be disagreeable to user 105) for recommendation. In an exemplary implementation, recommender system 125 may exclude items based on one or more criteria. For example, recommender system 125 may limit the number of co-occurred items to be included in an item table. Additionally, or alternatively, recommender system 125 may require that an item to be added to the item table satisfies a maximum threshold co-occurrence weight and/or satisfies a minimum threshold co-occurrence weight.

Referring to FIG. 1, in an exemplary scenario, assume user 105 is need of a recommendation for a particular item and transmits a recommendation request 135 to recommender system 125 via access network 120.

Recommender system 125 may obtain user's 105 user profile that lists all the items user 105 has used and rated and may retrieve the co-occurred items associated with those items from their corresponding item tables. However, since the co-occurred items associated with those items satisfied the one or more criteria previously described, recommender system 125 may generate 140 a recommendation response that includes serendipitous items for recommendation to user 105. As illustrated, recommender system 125 may provide a recommendation response to 145.

Although, in FIG. 1, it has been described that user 105 requests a recommendation to receive a recommendation response, in other implementations, recommender system 125 may provide a recommendation that is not user-initiated based. By way of example, in a business setting, a retailer may utilize recommender system 125 to select and push recommendations (e.g., advertisements) to customers.

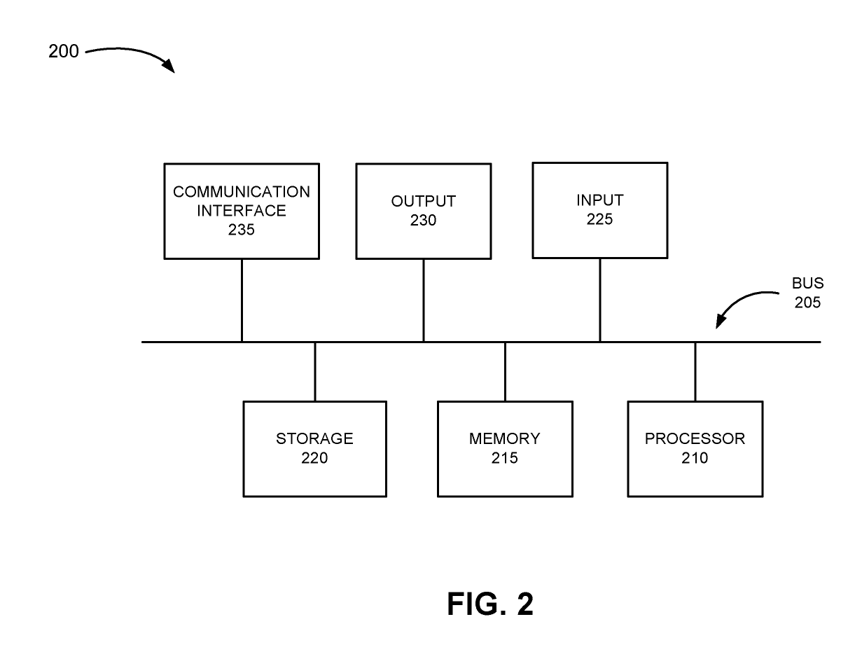

FIG. 2 is a diagram illustrating exemplary components of a device 200 that may correspond to one or more devices illustrated in environment 100. For example, device 200 may correspond to user device 110 and/or network devices associated with recommender system 125. As illustrated, device 200 may include a bus 205, a processor 210, memory 215, storage 220, an input 225, an output 230, and a communication interface 235.

Bus 205 may include a path that permits communication among the components of device 200. For example, bus 205 may include a system bus, an address bus, a data bus, and/or a control bus. Bus 205 may also include bus drivers, bus arbiters, bus interfaces, and/or clocks.

Processor 205 may interpret and/or execute instructions and/or data. For example, processor 205 may include one or more processors, microprocessors, data processors, co-processors, application specific integrated circuits (ASICs), system-on-chips (SOCs), application specific instruction-set processors (ASIPs), controllers, programmable logic devices (PLDs), chipsets, field programmable gate arrays (FPGAs), and/or some other processing logic that may interpret and/or execute instructions and/or data. Processor 205 may control the overall operation, or a portion thereof, of device 200, based on, for example, an operating system and/or various applications. Processor 205 may access instructions from memory 215, storage 220, other components of device 200, and/or from a source external to device 200 (e.g., another device or a network).

Memory 215 may store information (e.g., data, instructions, etc.). Memory 215 may include one or more volatile memories and/or one or more non-volatile memories. For example, memory 215 may include random access memory (RAM), dynamic random access memory (DRAM), static random access memory (SRAM), read only memory (ROM), programmable read only memory (PROM), ferroelectric random access memory (FRAM), erasable programmable read only memory (EPROM), flash memory, and/or some other form of storing hardware.

Storage 220 may store information (e.g., data, an application, etc.). For example, storage 220 may include one or more hard disks (e.g., magnetic disk, optical disk, magneto-optic disk, solid state disk, etc.) and/or some other type of storing medium (e.g., a computer-readable medium, a compact disk (CD), a digital versatile disk (DVD), or the like).

Input 225 may permit information to be input into device 200. For example, input 225 may include a keyboard, a keypad, a touch screen, a touch pad, a mouse, a port, a button, a switch, a microphone, voice recognition logic, an input port, a knob, and/or some other type of input component. Output 230 may permit information to be output from device 200. For example, output 230 may include a display, a speaker, light emitting diodes (LEDs), an output port, or some other type of output component.

Communication interface 235 may enable device 200 to communicate with other devices, systems, networks, etc. For example, communication interface 235 may include an Ethernet interface, an optical interface, a coaxial interface, a wireless interface, or the like. Communication interface 235 may include a transceiver component.

Although FIG. 2 illustrates exemplary components of device 200, in other implementations, device 200 may include fewer components, additional components, and/or different components than those depicted in FIG. 2 and described herein. Additionally, it will be appreciated that the arrangement of components depicted in FIG. 2 may be different in other implementations.

In an exemplary implementation, recommender system 125 may increase serendipity associated with items recommended to the user by excluding obvious items, rare items, and/or limiting the number of items included in the item table. As described below, recommender system 125 may determine whether a new item j should be added to item i's item table by calculating weighting factors and a co-occurrence weight.

For example, let an active item table correspond to an item table i and assume that item table i has a rating overlap with the items in the set Sᵢ={iᵢ,i₂,i₃ . . . iₖ}. Also assume that another item j, which is not in the set of Sᵢ, receives a new rating and, therefore, yields an overlap with item table i. The new item j may have an overlap with the items in the set Sᵢ={j₁,j₂,j₃ . . . j₁}. Cᵢ may be defined as the set of all co-ratings between item i and all the items in Sᵢ, where Cᵢ={cᵢ, i_{1,i1},c_{i,i2} . . . c_{i,ik}} and Cⱼ may be define as the set of all co-ratings between item j and the items in Sⱼ where Cⱼ={cᵢ, i_{j,j1},c_{j,j2} . . . c_{j,j1}}.

In an exemplary case, if item i and item j have a co-occurrence of 20, it may be difficult to determine whether 20 represents a high or a low level of co-occurrence. To determine whether 20 may be a high or a low level co-occurrence, 20 may be compared with a number of co-occurrences in Cᵢ. In an exemplary case, if an average number of Cᵢ is 200, then it may be reasonable to conclude that 20 is not a high level of co-occurrence. However, the number of co-occurrences between item i and item j with the number of co-occurrences in Cⱼ may be compared. In an exemplary case, if the average number of Cⱼ is 4, then 20 may indicate a quite high co-occurrence. There may be two factors that influence the co-occurrence between item i and item j and that is how both item i and item j co-occurs with other items, respectively.

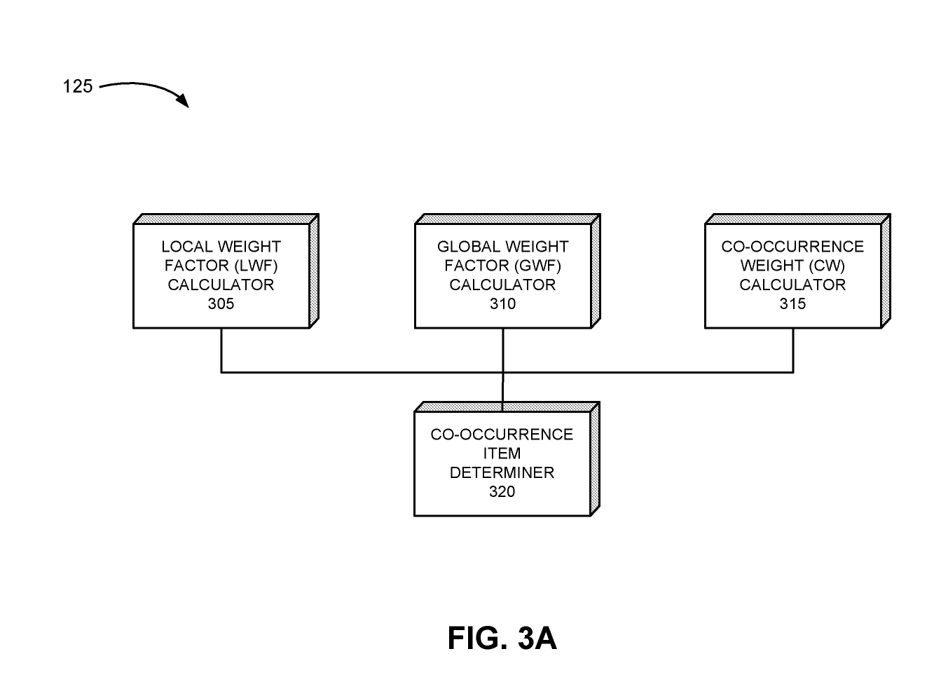

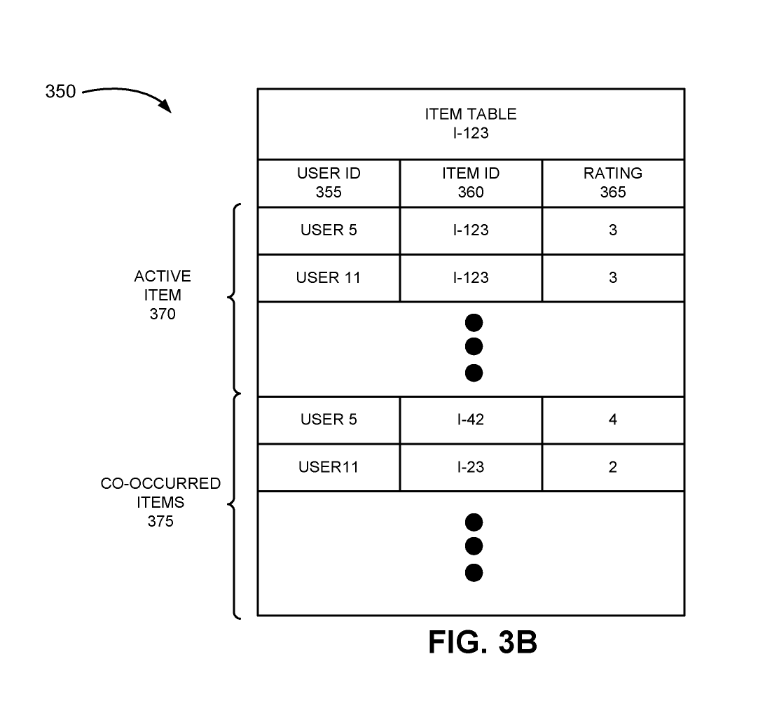

FIG. 3A is a diagram illustrating exemplary functional components associated with recommender system 125. As illustrated, recommender system 125 may include a local weighting factor (LWF) calculator 305, a global weighting factor (GWF) calculator 310, a co-occurrence weight (CW) calculator 315, and a co-occurrence item determiner (CID) 320. LWF calculator 305, GWF calculator 310, CW calculator 315, and/or CID 320 may be implemented as a combination of hardware and software, hardware, or software based on the components illustrated in FIG. 2 and described herein.

LWF calculator 305 may calculate a LWF. The LWF may be calculated based on the co-occurrences of an item i at i's network device of recommender system 125. The LWF may be considered “local” since data needed to calculate the LWF may be available on one of the network devices of recommender system 125. For example, if item i's item table is stored on recommender system 125-1, recommender system 125-1 may not need to obtain data (e.g., co-occurrence items) from recommender system 125-2 to calculate the LWF.

LWF calculator 305 may calculate the LWF based on various algorithms, methods, or expressions. For example, LWF calculator 305 may calculate the LWF based on frequency, binary, or log of term frequency. The frequency approach provides a measurement of a frequency in which a given item appears in an item table. The binary approach replaces any item frequency, which is greater than or equal to a value of 1, with a value of 1. The log of term frequency approach takes a log of the raw co-occurrences. Thus, the log of term frequency approach may dampen the effects of large differences in term frequencies. The log of term frequency approach may be expressed as:

log(c_{i,j}+1).

Given the number of different local weighting approaches available, it will be appreciated that other algorithms, methods, or expressions not specifically described herein may be utilized to calculate the LWF.

GWF calculator 310 may calculate a GWF. The GWF may be calculated based on all co-occurrences for an item j not only at i's network device, but all network devices of recommender system 125. The GWF may be considered “global” since data needed to calculate the GWF may be available on multiple network devices of recommender system 125.

GWF calculator 310 may calculate the GWF based on various algorithms, methods, or expressions. For example, GWF calculator 310 may calculate the GWF based on inverse document frequency (IDF), entropy, global weight inverse document frequency (GFIDF), normal, or a modified entropy. Application of these weighting schemes may yield the following exemplary expressions in which c_{i,j} may represent the co-occurrence between item i and item j; size(C_{J}) may represent the number of occurrences that item j has with other items; and sum(C_{J}) may represent the sum of all co-occurrences with C_{J}:

$$Normal : \frac{1}{\sqrt{{\sum }_{j ∈ {C}_{j}} {c}_{{ }_{i , j}}^{2}}}$$

$$GFIDF : \frac{size ( {C}_{j} )}{sum ( {C}_{j} )}$$

$$IDF : {log}_{2} [ \frac{n}{size ( {C}_{j} )} ]$$

where n is the total number of items

$$Entropy : \\ 1 + \frac{{\sum }_{j ∈ {C}_{j}} ( {c}_{{ }_{i , j}} log ( {c}_{{ }_{i , j}} ) ) - size ( {C}_{j} ) log ( size ( {C}_{j} ) )}{size ( {C}_{j} ) log ( n )}$$

$$Modified Entropy : \\ 1 + \frac{\frac{1}{size ( {C}_{j} )} {\sum }_{j ∈ {C}_{j}} ( {c}_{{ }_{i , j}} log ( {c}_{{ }_{i , j}} ) ) - log ( size ( {C}_{j} ) ) + log ( n ) - log ( {N}_{epoch} )}{log ( {N}_{epoch} )}$$

It will be appreciated, however, that entropy has one drawback in that as the number of items grow, co-occurrences having very low co-occurrence values may come to dominate. However, modified entropy may reduce the possibility of co-occurrences having very low co-occurrence values from becoming dominate by including an epoch size. One epoch may constitute one loop through the data in an item table (e.g., item table j). This is equivalent to setting a lower bound on co-occurrence to one co-occurrence per epoch. In this way, mid-level co-occurrences items may become more important. Further, the modified entropy may operate incrementally which may permit its use on streaming data.

Given the number of global weighting schemes available, it will be appreciated that other algorithms, methods, or expressions not specifically described herein may be utilized to calculate a GWF.

CW calculator 315 may calculate a CW. In an exemplary implementation, CW calculator 315 may calculate the CW based on the LWF and the GWF. For example, CW calculator 315 may calculate the CW based on the following expression:

CW=GWF*LWF,

in which the LWF and the GWF are multiplied. In other implementations, CW calculator 315 may calculate the CW based on a different expression. For example, the CW may be represented as a ratio between the LWF and the GWF, etc.

CID 320 may determine whether a CW value satisfies one or more criteria. In an exemplary implementation, CID 320 may compare the CW value to a maximum threshold CW value and/or a minimum threshold CW value. The threshold values may be static or dynamic. Additionally, or alternatively, the threshold values may be tailored for each item type. Additionally, or alternatively, CID 320 may limit a size (e.g., the number of items) of an item table. For example, the number of co-occurred items in the item table may be limited to a specified number. The specified number may be static or dynamic. The specified number may be tailored to the item type.

As previously described, in an exemplary implementation, recommender system 125 may distribute the data to item tables. The item tables may be distributed according to the Chord protocol. In an exemplary implementation, each item may have a corresponding item table.

FIG. 3B is a diagram illustrating an exemplary item table 350 that may include an active item and co-occurred items. As illustrated, item table 350 may include a user ID field 355, an item ID field 360, and a rating field 365. The term “item table,” as used herein, is intended to be broadly interpreted to correspond to an item neighborhood.

User ID field 355 may include some kind of unique identifier for each user 105. For example, the user identifier may take the form of a string (e.g., a numerical string, an alphanumerical string, an alphabetic string, etc.).

Item ID field 360 may include some kind of unique identifier for each item. For example, the item identifier may take the form of a string (e.g., a numerical string, an alphanumerical string, an alphabetic string, etc.). For example, an item ID for a book may correspond to an International Standard Book Number (ISBN).

Rating field 365 may include rating information indicative of a rating system. For example, the rating information may take the form of a string (e.g., a numerical string, an alphanumerical string, an alphabetic string, etc.). For example, the rating system may permit a user to select from a range of integer values.

As further illustrated, based on user ID field 355, item ID field, and rating field 365, item table 350 may include data associated with an active item 370 and co-occurred items 375. For example, active item 370 may correspond to a movie, and co-occurred items 375 may correspond to similar items, which may include other movies, or other types of items (e.g., books, music, etc.). Co-occurred items 375 may have a measure of similarity (or co-occurrence) with respect to active item 370. However, as described herein, recommender system 125 may exclude obvious co-occurred items, rare co-occurred items, and/or limit the size (e.g., the number of co-occurred items 375) of item table 350.

Although FIG. 3B illustrates an exemplary item table 350, in other implementations, item table 350 may include additional and/or different fields. For example, item table 350 may include a time stamp field, a hash ID field, a field that references another item table, etc.

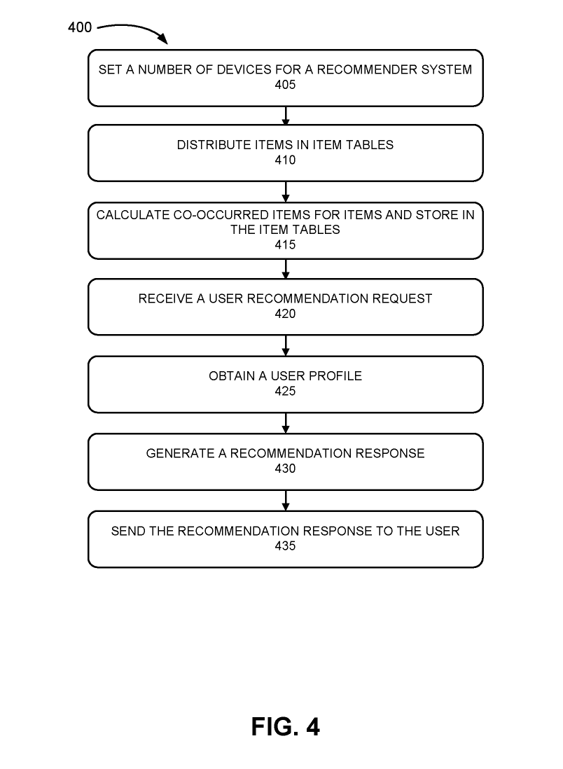

FIG. 4 is a flow diagram illustrating an exemplary process 400 for providing a recommender system and a recommendation service. The exemplary process 400 may be performed by recommender system 125. For purposes of discussion, it may be assumed that a corpus of data exists. For example, the corpus of data may include information identifying items, users, and ratings.

Process 400 may include setting a number of devices for a recommender system (405). For example, recommender system 125 may include a particular number of network devices corresponding to recommender system 125-1 through 125-N, where N represents the number of network devices. It will be appreciated, however, that the Chord protocol allows network devices to enter and leave the Chord network. In an exemplary implementation, these network devices may form a Chord network. Recommender system 125 may assign a node ID to each network device associated with recommender system 125. For example, a network address associated with the network device may be hashed to form the node ID. In other implementations, other types of attributes (e.g., device ID, etc.) may be used to form the node ID.

Items for the item tables may be distributed (block 410). For example, data may be received and stored by recommender system 125. The data may include information identifying users, items, and ratings. Recommender system 125 may generate item tables 350 based on the received data. In an exemplary implementation, recommender system 125 may distribute item tables 350 using the Chord protocol. For example, if N=20 (i.e., the number of network devices associated with recommender system 125) and there are 1000 item tables 350, then with an even distribution, each network device associated with recommender system 125 may store 50 item tables 350. As previously described, in an exemplary implementation, item tables 350 may include, among other things, a user ID field 355, an item ID field 360, and a rating field 365. Network devices associated with recommender system 125 may generate routing tables (referred to in the Chord protocol as finger tables) which, among other things, may map node IDs to item IDs field 360.

Co-occurred items for items may be calculated and stored in the item tables (block 415). For example, recommender system 125 may calculate the similarity between active items 370 and store items determined to be similar, as co-occurred items 375. In an exemplary implementation, recommender system 125 may utilize various methods to determine similarities between active items 370. In an exemplary implementation, recommender system 125 may calculate the similarity between items based on a correlation-based similarity (e.g., the Pearson correlation coefficient, Spearman's rank correlation coefficient, Kendall's correlation coefficient, etc.). In other implementations, recommender system 125 may utilize other methods to determine similarities (e.g., Cosine-based similarity, Adjusted Cosine, etc.). Additionally, or alternatively, recommender system 125 may calculate co-occurred items for item tables 350 based on the process described below.

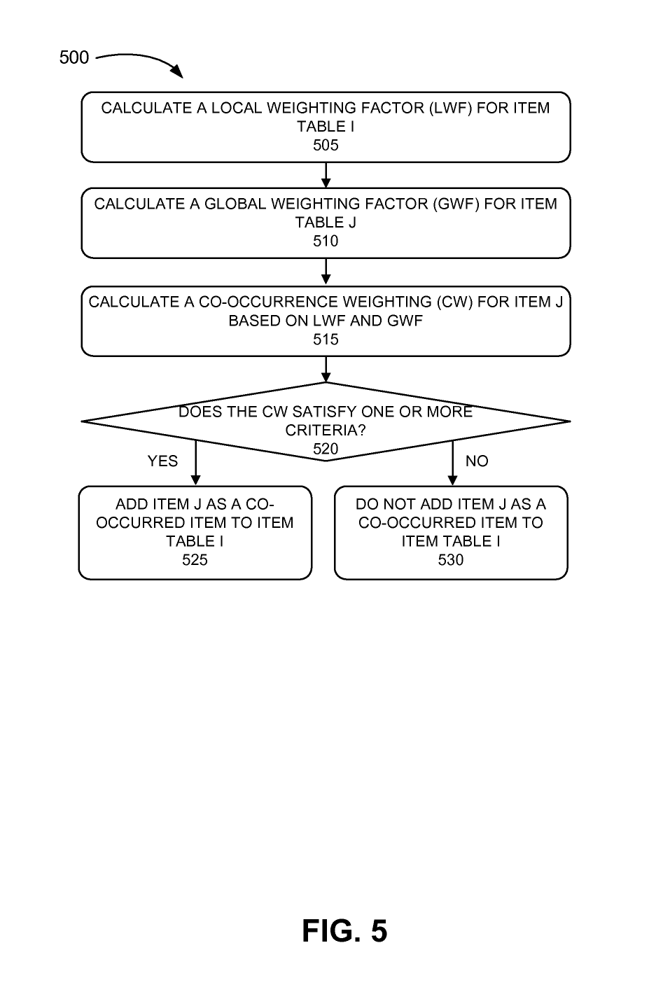

FIG. 5 is a flow diagram illustrating an exemplary process 500 for determining whether an item may be added as a co-occurred item in an item table. For example, assume recommender system 125 is determining whether an item j may be added to item i's item table.

Process 500 may include calculating a LWF for an item table (block 505). LWF calculator 305 may calculate a LWF. The LWF may be calculated based on co-occurrence items associated with item i. The LWF may be considered a “local” weighting factor since, in an exemplary implementation, the data needed to calculate the LWF may be available on the network device (e.g., recommender system 125-1) that hosts item i's item table. Thus, recommender system 125-1 may not need to obtain data from another network device (e.g., recommender system 125-2), which may minimize resource utilization, time, etc.

LWF calculator 305 may calculate the LWF based on various algorithms, methods, or expressions. For example, as previously described, LWF calculator 305 may calculate the LWF based on frequency, binary, or log of term frequency.

Given the number of local weighting schemes available, it will be appreciated that other algorithms, methods, or expressions not specifically described herein may be utilized to calculate the LWF.

A GWF for an item table may be calculated (block 510). GWF calculator 310 may calculate a GWF. The GWF may be calculated based on all co-occurrences for an item j (i.e., not only at item i's network device, but all network devices of recommender system 125). In an exemplary implementation, GWF calculator 310 may calculate the GWF based on various algorithms, methods, or expressions. For example, GWF calculator 310 may calculate the GWF based on inverse document frequency (IDF), entropy, global weight inverse document frequency (GFIDF), normal, or a modified entropy. Application of these weighting schemes may yield the following exemplary expressions in which c_{i,j} may represent the co-occurrence between i and j; size(C_{J}) may represent the number of occurrences that j has with other items; and sum(C_{J}) may represent the sum of all co-occurrences with C_{J}:

$$Normal : \frac{1}{\sqrt{{\sum }_{j ∈ {C}_{j}} {c}_{{ }_{i , j}}^{2}}}$$

$$GFIDF : \frac{size ( {C}_{j} )}{sum ( {C}_{j} )}$$

$$IDF : {log}_{2} [ \frac{n}{size ( {C}_{j} )} ]$$

where n is the total number of items

$$Entropy : \\ 1 + \frac{{\sum }_{j ∈ {C}_{j}} ( {c}_{{ }_{i , j}} log ( {c}_{{ }_{i , j}} ) ) - size ( {C}_{j} ) log ( size ( {C}_{j} ) )}{size ( {C}_{j} ) log ( n )}$$

$$Modified Entropy : \\ 1 + \frac{\frac{1}{size ( {C}_{j} )} {\sum }_{j ∈ {C}_{j}} ( {c}_{{ }_{i , j}} log ( {c}_{{ }_{i , j}} ) ) - log ( size ( {C}_{j} ) ) + log ( n ) - log ( {N}_{epoch} )}{log ( {N}_{epoch} )}$$

Given the number of global weighting schemes available, it will be appreciated that other algorithms, methods, or expressions not specifically described herein may be utilized to calculate the GWF.

A co-occurrence weight (CW) may be calculated based on the LWF and the GWF (block 515). For example, CW calculator 315 of recommender system 125 may calculate a CW based on the LWF and the GWF. In an exemplary implementation, CW calculator 315 may calculate the CW based on the expression:

CW=GWF*LWF,

in which the LWF and the GWF are multiplied. In other implementations, CW calculator 315 may calculate the CW based on a different expression. For example, the CW may be represented as a ratio between the LWF and the GWF, etc.

It may be determined whether the CW satisfies one or more criteria (block 520). For example, CID 320 may determine whether the calculated CW satisfies one or more criteria. In an exemplary implementation, the one or more criteria may include a maximum threshold CW value, a minimum threshold CW value, and/or a limited size (e.g., in terms of number of items) of an item table (e.g., item i's item table). As described herein, CID 320 may determine whether the calculated CW satisfies the maximum threshold CW value and/or the minimum threshold CW value by comparing the CW value to one or both of these threshold CW values. Additionally, CID 320 recognize the number of items included in item i's item table and compare that number to an item table limit value.

The maximum threshold CW value and the minimum threshold CW value associated with a particular item (e.g., item i, item j, etc.), and the item table limit value associated with an item table (e.g., item i's item table), may be (initially) set by an administrator of recommender system 125. It will be appreciated, however, that the maximum threshold CW value, the minimum CW threshold value, and/or the item table limit value may be static or dynamic (e.g., adapt to feedback received from users 105 utilization of recommender system, etc.) values. Additionally, or alternatively, the maximum threshold CW value, the minimum CW threshold value, and/or the item table limit value may be tailored to a particular item (e.g., a particular movie, a particular book, etc.), a genre associated with one or more items (e.g., action movies, etc.), or other characteristics associated with the item.

If it is determined that the item satisfies the one or more criteria (block 520-YES), the item may be added as a co-occurred item to the item table (block 525). For example, if CID 320 determines that the CW value satisfies the one or more criteria, CID 320 may add the item as a co-occurred item in the item table. For example, item j may be added as a co-occurred item to item i's item table.

If it is determined that the item does not satisfy the one or more criteria (block 520-NO), the item may not be added as a co-occurred item to the item table (block 530). For example, if CID 320 determines that the CW value does not satisfy the one or more criteria, CID 320 may not add the item as a co-occurred item in the item table. For example, item j may not be added as a co-occurred item to item i's item table.

Referring back to FIG. 4, a user recommendation request may be received (block 420). For example, user 105 may send a recommendation request 135 to recommender system 125 via user device 110.

A user profile may be obtained (block 425). For example, recommender system 125 may obtain the user profile from user device 110 in response to receiving recommendation request 135. As previously described, in an exemplary implementation, the user profile may include a list of all items user 105 has used and user's 105 ratings of these items. For example, the user profile may correspond to a format [Item ID, Rating]=[1,3], [2,4], [5,5], etc.

A recommendation response may be generated (block 430). For example, recommender system 125 may obtain, based on the Chord protocol, all the co-occurred items associated with the items included in user's 105 user profile. For example, if item i is included in user's 105 user profile, recommender system 125 may obtain all the co-occurred items from item i's item table (which may or may not include item j). Recommender system 125 may calculate a similarity for all co-occurred items in each item table based on the previously described methods (e.g., a correlation-based similarity, a Cosine-based similarity, an Adjusted Cosine, etc.). The recommendation response may be sent to the user (block 435). For example, recommender system 125 may send a recommendation response 145 to user 105. In an exemplary implementation, recommendation response 145 may include a list of similar items scaled by their rating values. However, unlike a conventional recommender system, the list of similar items may include serendipitous items since the co-occurred items in the items tables have been limited based on the one or more criteria, as previously described.

User device 110 may receive recommendation response 145. Depending on the user interface provided by user device 110 and/or recommender system 125, user 105 may be presented with an item recommendation(s) in various forms (e.g., a sorted list based on a specified criterion (e.g., top 10), etc.).

Although FIG. 4 illustrates an exemplary process 400, in other implementations, fewer operations, additional operations, and/or different operations may be performed. For example, while it has been described that various weighting factors (e.g., the LWF and the GWF) may be calculated, in an exemplary implementation, the weighting factors may be pre-calculated. For example, the GWF associated with an item may be considered a relatively static value. Thus, item table 350 may store the GWF associated with a particular item. Additionally, an item table 350 that has not added a certain number of new co-occurred items (i.e., has changed very little or not at all) may utilize a previously computed LWF. Thus, in some instances, the GWF and/or the LWF may be pre-calculated, which may improve efficiency, resource utilization, communication between network devices of the recommender system 125, etc. Furthermore, the GWF may be managed as metadata of an item. In an exemplary case, an item j that has been determined to qualify as a co-occurred item with respect to an item i's item table may store the GWF associated with item j. Again, such an implementation may improve efficiency, resource utilization, communication between network devices of the recommender system, etc.

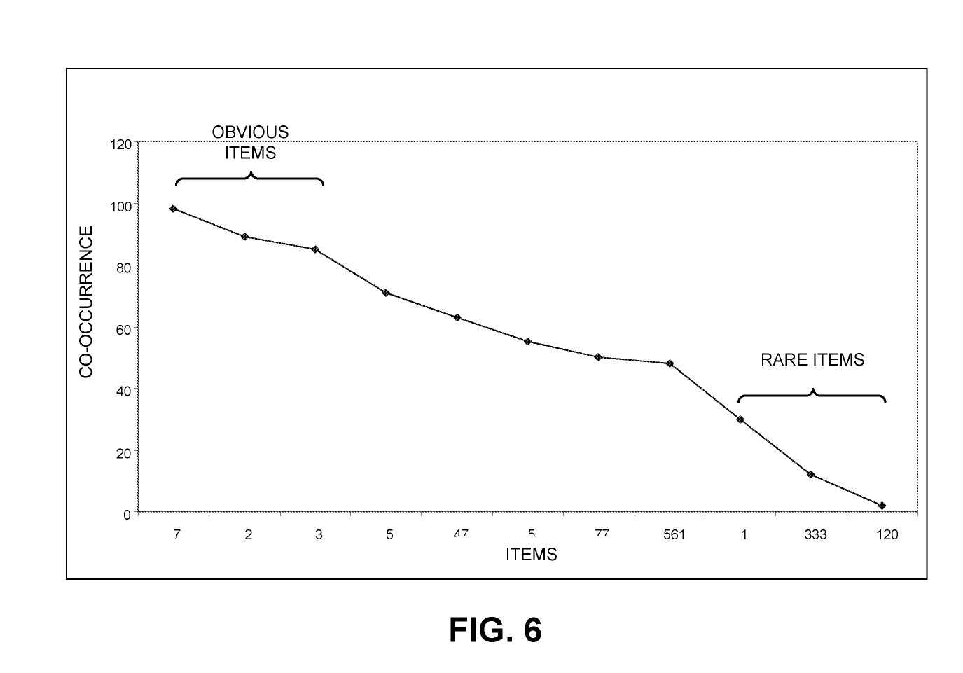

As described herein, a recommender system may increase the serendipity associated with a recommendation (e.g., an item). Additionally, or alternatively, the recommender system may reduce the amount of data stored in each item table. For example, as described herein, co-occurred items may be omitted if the co-occurred items do not satisfy one or more criteria. Stated differently, co-occurred items considered too obvious or too rare may be omitted from item tables based on threshold CW values, as illustrated in FIG. 6. For example, the maximum threshold CW value may omit obvious items and the minimum threshold CW value may omit rare items. Additionally, or alternatively, the size of the item table may be limited. As a result, complexities associated with generating a recommendation may be significantly improved, which in turn may improve performance and efficiency metrics (e.g., response time) of the recommender system, as well as other advantages that may necessarily flow there from. These benefits may be especially valuable in a real-time system. Also, by minimizing resource utilization, costs of the recommender system (e.g., reduced data storage, reduced processing, etc.) may be minimized.

Increasing a level of serendipity in a recommender system may correspondingly increase an explore factor for those receiving recommendations. By way of example, in a business setting, an increase in the explore factor may potentially broaden customers' interests by introducing customers to products the customers may not otherwise have discovered and/or considered. In instances when customers are content with recommendations they receive, customer satisfaction may increase, as well as potential revenue. Furthermore, customers that are satisfied may utilize the recommender system more frequently, which in turn, may provide the recommender system with more feedback. As a result of this positive loop, the recommender system may gain more knowledge to further improve its recommendations.

The foregoing description of implementations provides illustration, but is not intended to be exhaustive or to limit the implementations to the precise form disclosed. Modifications and variations are possible in light of the above teachings or may be acquired from practice of the teachings.

In addition, while series of blocks have been described with regard to the processes illustrated in FIGS. 4 and 5, the order of the blocks may be modified in other implementations. Further, non-dependent blocks may be performed in parallel. It will be appreciated that the process and/or operations described herein may be implemented as a computer program. The computer program may be stored on a computer-readable medium (e.g., a memory, a hard disk, a CD, a DVD, etc.) or represented in some other type of medium (e.g., a transmission medium).

It will be apparent that aspects described herein may be implemented in many different forms of software, firmware, and/or hardware in the implementations illustrated in the figures. The actual software code or specialized control hardware used to implement aspects does not limit the invention. Thus, the operation and behavior of the aspects were described without reference to the specific software code—it being understood that software, firmware, and/or control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

It should be emphasized that the term “comprises” or “comprising” when used in the specification is taken to specify the presence of stated features, integers, steps, or components but does not preclude the presence or addition of one or more other features, integers, steps, components, or groups thereof.

No element, act, or instruction used in the present application should be construed as critical or essential to the implementations described herein unless explicitly described as such.

The term “may” is used throughout this application and is intended to be interpreted, for example, as “having the potential to,” configured to,” or “capable of,” and not in a mandatory sense (e.g., as “must”). The terms “a” and “an” are intended to be interpreted to include, for example, one or more items. Where only one item is intended, the term “one” or similar language is used. Further, the phrase “based on” is intended to be interpreted to mean, for example, “based, at least in part, on,” unless explicitly stated otherwise. The term “and/or” is intended to be interpreted to include any and all combinations of one or more of the associated list items.

1. A method performed in a network by devices that provide a recommendation of content to a user, the method comprising:
distributing items in item tables stored by the devices;
calculating whether an item has a co-occurrence with another item, which is associated with one of the item tables, wherein the calculating comprises: calculating a local weighting factor that represent a co-occurrence between the other item and co-occurred items included in the one of the item tables, calculating a global weighting factor that represent a co-occurrence between the item and the items in the item tables, calculating a co-occurrence weight based on the local weighting factor and the global weighting factor, and determining whether the co-occurrence weight satisfies one or more criteria; and
storing the item as a co-occurred item in the one of the item tables when the co-occurrence weight is determined to satisfy the one or more criteria.

2. The method of claim 1, wherein the one or more criteria includes one or more of a limited number of co-occurred items for each item table, a maximum value for the co-occurrence weight, or a minimum value for the co-occurrence weight.

3. The method of claim 2, wherein the maximum value for the co-occurrence weight corresponds to a measurement of obviousness and the minimum value for the co-occurrence weight corresponds to a measurement of rareness.

4. The method of claim 1, further comprising:
receiving a recommendation request from the user; and
sending a recommendation response to the user based on the item tables.

5. The method of claim 1, wherein the items correspond to one or more of books, movies, consumer products, services, restaurants, or music.

6. The method of claim 1, wherein the devices operate according to a Chord protocol.

7. The method of claim 1, wherein the global weighting factor is calculated based on one of an inverse document frequency (IDF) expression, an entropy expression, a global weight inverse document frequency (GFIDF), a normal expression, or a modified entropy expression.

8. The method of claim 1, wherein the local weighting factor is calculated based on one of a log (term frequency+1) expression, a frequency expression, or a binary expression.

9. The method of claim 1, where wherein entries of the one of the item tables, which correspond to the other item and the co-occurred items, include a user identifier, an item identifier, and a user rating for a particular item.

10. One or more computer-readable media storing instructions to:
distribute items in item tables on devices;
calculate whether an item has a co-occurrence with another item, which is associated with one of the item tables, wherein the instructions to calculate comprise instructions to: calculate a local weighting factor that represents a co-occurrence between the other item and co-occurred items included in the one of the item tables, calculate a global weighting factor that represents a co-occurrence between the item and the items in the item tables, calculate a co-occurrence weight based on the local weighting factor and the global weighting factor, and determine whether the co-occurrence weight satisfies one or more criteria; and
store the item as a co-occurred item in the one of the item tables when the co-occurrence weight is determined to satisfy the one or more criteria.

11. The one or more computer-readable media of claim 10, wherein the one or more criteria includes one or more of a limited number of co-occurred items for each item table, a maximum value for the co-occurrence weight, or a minimum value for the co-occurrence weight.

12. The one or more computer-readable media of claim 11, wherein the maximum value for the co-occurrence weight corresponds to a measurement of obviousness and the minimum value for the co-occurrence weight corresponds to a measurement of rareness.

13. The one or more computer-readable media of claim 12, wherein the instructions to determine comprise instructions to:
compare the maximum value for the co-occurrence weight with the co-occurrence weight; and
compare the minimum value for the co-occurrence weight with the co-occurrence weight.

14. The one or more computer-readable media of claim 10, wherein the co-occurrence weight is a value equal to a result from a multiplicative operation between the local weighting factor and the global weighting factor.

15. The one or more computer-readable media of claim 10, wherein the devices correspond to an item-based collaborative filtering recommendation system.

16. A device Devices in a network, the device comprising:
one or more processors and one or more memories to execute instructions to:
distribute items in item tables stored by the one or more devices;
calculate whether an item has a co-occurrence with another item, which is associated with one of the item tables, wherein, when calculating, the one or more processors are to: calculate a local weighting value that represents a co-occurrence between the other item and co-occurred items included in the one of the item tables, calculate a global weighting value that represents a co-occurrence between the item and the items in the item tables, calculate a co-occurrence weight based on the local weighting value and the global weighting value, and determine whether the co-occurrence weight satisfies one or more criteria;
store the item as a co-occurred item in the one of the item tables when it is determined that the co-occurrence weight satisfies the one or more criteria;
receive a recommendation request from a user; and
send a recommendation response to the user based on the item tables.

17. The device of claim 16, wherein the one or more criteria includes one or more of a limited number of co-occurred items for each item table, a maximum value for the co-occurrence weight, or a minimum value for the co-occurrence weight.

18. The device of claim 17, wherein the maximum value for the co-occurrence weight corresponds to a measurement of obviousness and the minimum value for the co-occurrence weight corresponds to a measurement of rareness.

19. The device of claim 16, wherein the device operates according to the Chord protocol.

20. The device of claim 16, wherein the items correspond to one or more of books, movies, consumer products, services, restaurants, or music.
